(19) United States
(12) Patent Application Publication
(10) Pub. No.: US 2026/0134326 A1
(43) Pub. Date: May 14, 2026

(54) Scaling Using ML to Detect Advantage on Quantum Simulation Problems

(71) Applicant: Dell Products L.P., Round Rock, TX (US)

(72) Inventors: Miguel PAREDES QUIÑONES, Campinas (BR); Ítalo Gomes SANTANA, Rio de Janeiro (BR); Diego Diego NOBLE, Pelotas (BR); Ana SMITH, Chicago, IL (US)

(21) Appl. No.: 18/927,042

(22) Filed: Oct. 25, 2024

(51) Int. Cl. G06N 10/60; G06N 3/0475; G06N 10/20

(52) U.S. Cl. CPC G06N 10/60; G06N 3/0475; G06N 10/20

(57) ABSTRACT

A method is disclosed for optimizing Quadratic Unconstrained Binary Optimization (QUBO) instances for efficient execution on a quantum computer. Initially, a first machine learning (ML) model receives a QUBO instance along with scaling and scheduling parameters. The first ML model transforms the QUBO instance into a scaled version and adjusts the scheduling parameters accordingly. Subsequently, a second ML model compares the scaled QUBO instance and parameters with those of a known efficiently executable QUBO instance on a quantum computer. Based on this comparison, the second ML model assigns a score to the scaled QUBO instance, indicating its efficiency for execution on the quantum computer. This method enables the optimization of QUBO instances for enhanced quantum computing performance.

### TECHNOLOGICAL FIELD OF THE DISCLOSURE

One or more embodiments disclosed herein generally relate to resolution of Quadratic Unconstrained Binary Optimization (QUBO) problems. More particularly, at least some embodiments relate to systems, hardware, software, computer-readable media, and methods for using machine-learning models to determine if specific QUBO problems would benefit from being executed on a quantum computer.

### BACKGROUND

Quantum advantage/supremacy means that a quantum algorithm executed on a quantum computer (also referred to as a quantum annealer) is more efficient to solve a specific problem than when any classical algorithm is executed on a classical computer. This efficiency can be related to computational time or usage of computational resources (e.g., memory), and this advantage/supremacy is often obtained by the intrinsic characteristics of quantum computers.

However, in many instances it can be difficult to determine if the quantum algorithm is able to be executed on the quantum computer. This process often requires running a large number of simulations using classical computing systems, which can consume a large amount of system resources.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of different time schedule scaling for determined energy scales κ (scale of the Hamiltonian problem energy).

FIGS. 2A-2D disclose aspects of determining if a QUBO instance can be efficiently executed on a quantum computer.

FIG. 3 discloses aspects of a method according to one embodiment.

FIG. 4 discloses a computing entity configured and operable to perform any of the disclosed methods, processes, and operations.

### DETAILED DESCRIPTION OF SOME EXAMPLE EMBODIMENTS

One or more embodiments disclosed herein generally relate to resolution of Quadratic Unconstrained Binary Optimization (QUBO) problems. More particularly, at least some embodiments relate to systems, hardware, software, computer-readable media, and methods for using machine-learning models to determine if specific QUBO problems would benefit from being executed on a quantum computer.

One example method includes, at a first machine learning (ML) model, receiving a Quadratic Unconstrained Binary Optimization (QUBO) instance, the QUBO instance including one or more features. The first ML model receives one or more scaling parameters and one or more scheduling parameters that are associated with the QUBO instance. The first ML model transforms the QUBO instance into a scaled QUBO instance that includes one or more scaled features and the first ML model transforms the one or more scheduling parameters into one or more scaled scheduling parameters that are associated with the scaled QUBO instance. A second ML model receives the scaled QUBO instance and the one or more scaled scheduling parameters. The second ML model compares the one or more scaled features and the one or more scaled scheduling parameters with the one or more features and associated scheduling parameters of a second QUBO instance that has been found to be efficiently executable on a quantum computer. The second ML model, based on the comparison, assigns a score to the scaled QUBO instance, the score indicating whether the scaled QUBO instance is efficiently executable on the quantum computer.

### A. Context for an Example Embodiment

The following is a discussion of aspects of a context for various embodiments. This discussion is not intended to limit the scope of the claims or this disclosure, or the applicability of the embodiments, in any way. One problem that quantum computers can solve is the simulation of quantum systems, more specifically, these quantum systems are represented as Hamiltonian functions that evolve in time. Classical simulation methods can faithfully replicate this evolution, but generally require time and memory resources that scale exponentially with the problem size. To solve a quantum simulation problem in general, some of the following classical methods can be used:
MPS (Matrix Product States) are designed to reduce the complexity from exponential in N to

$${N}^{\frac{d - 1}{d}} ,$$

where d is the number of dimensions. The trade-off between solution quality and computational cost can be controlled by a maximum number of d. This method can be used to obtain ground truth of quantum simulations because of the low computational cost compared with other methods.
PEPS (Projected entangled-pairs States) are better aligned with the geometry of the problem and so can encode more efficiently states with area law beyond one dimension.
NQS (Neural Quantum States) are used to approximate wave functions and compute ground states, however, methods in this class have only few examples related to time evolution.

Other classical specialized methods can be used to obtain good results but depends not only on the quantum simulation problem that is desired to be solved but also normally those methods are tailored and restricted to one domain.

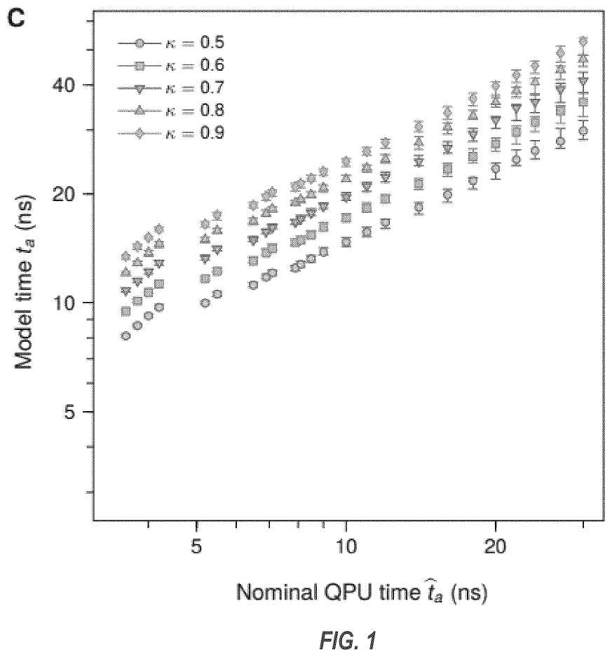

To solve a quantum simulation problem, it is necessary to make a transformation to fit this time evolution problem into the time evolution of the quantum hardware. For example, it is necessary to build a transformation of the quantum magnet simulation problem into the Traverse Field Ising Model (TFIM) schedule to make possible the numerical evolution of its time-dependent Schrödinger equation into a quantum annealing device. As the annealing schedule dictates the time scales for the Schrödinger evolution, thus, a calibration over the QPUs is required. This calibration is necessary to make each QPU operational in the schedule (from its own time scale). This time schedule consists of series of time frames that executes the Schrodinger time evolution. The total time of the simulation is called quenching time tₐ. Due to the specifics of controlling waveforms at the device speed, the effective quench time tₐ is not a smooth or monotone function of the nominal (i.e., requested) quench time \hat{t}ₐ. To find the equivalence between these two times, an exhaustive procedure needs to be performed. The variations of possible schedules and scales are performed to check if [symbol] q2 [symbol] (order parameter), a measurement of coherence on the results is next to 1 for one of the schedules and scales. For example, FIG. 1 shows different time schedules scaling for determined energy scales κ (scale of the Hamiltonian problem energy).

Also, the process of matching the qubit graph with a hardware graph is necessary, but, in most of the cases, this can be done only by solving an instance of the subgraph isomorphism (the problem is a subgraph of the hardware graph) instead of solving the minor embedding problem.

Thus, it can be difficult to determine if a quantum simulation problem is able to be efficiently executed on the quantum computer. This process often requires running a large number of classical simulations using classical computing systems, which can consume a large amount of system resources. In addition, an issue with simply simulating the quantum simulation problem using a real quantum computer is that not all quantum simulation problems can be accurately simulated with the quantum computer. In some specific cases, the classical simulations can solve the quantum simulation problem in a reasonable amount of time and with better accuracy.

### B. Overview of Aspects of One or More Embodiments

The embodiments herein provide a novel way to determine if a quantum simulation problem is able to be simulated using a quantum computer such as a quantum annealer and if the quantum simulation problem would benefit from being simulated using the quantum computer. In other words, the embodiments disclosed herein determine if a quantum simulation problem has some form of quantum advantage. The embodiments are based on the identification of an equivalence of a quantum simulation problem onto another quantum simulation problem that has similar characteristics or features, but are of different problem types. Thus, if there is a pool of quantum simulation problems that have been determined to have some form of quantum advantage and a new quantum simulation problem of differing type that has not yet been determined to have a quantum advantage, then the similar characteristics or features of the quantum simulation problems can be used to determine if there is an equivalence between the quantum simulation problems. If it is determined that such equivalence exists, then it can be inferred that the new quantum simulation problem has a quantum advantage.

The embodiments herein are described using Quadratic Unconstrained Binary Optimization (QUBO) problems or, in short, QUBO problems, or simply QUBOs. A QUBO is a kind of format used to facilitate combinatorial optimization and many real-world problems can be encoded in this format. Stated differently QUBO is a particular way to encode an optimization problem (i.e. a way to mathematically represent the optimization problem). The QUBO format typically includes a single, multi-variable quadratic polynomial called the Hamiltonian “Q.” Typically, the objective with regard to Q is to minimize its value. The QUBO format has been popularized in part by the advent of Quantum Annealing (QA), which tries to interpolate between (i) a static problem-independent Hamiltonian H₀ for which the ground state can be efficiently prepared and (ii) a final Hamiltonian whose ground state yields the desired answer. The QA system linearly interpolates between H₀ and H_{f} to equal Q. The system is manipulated in the manner of leveraging a quantum tunneling effect that helps the system move closer to the ground state. As used herein, the word QUBO can have two meanings depending on the context: (1) a QUBO is an abstract form that represents a form of encoding an optimization problem in the specific format; and (2) a QUBO problem instance or QUBO matrix is a concrete form, or instance, of an optimization problem encoded as a QUBO—this concrete form may be understood as a final stage before the problem is solved—in this stage, all coefficients and variables are defined. It is noted that both QUBOs and Ising models are equivalent through a polynomial-time transformation, therefore an embodiment may adopt only the QUBO representation, for the sake of brevity.

QUBOs can have several different types or structures of problems. For example, several known QUBO problem types include, but are not limited to, the number partitioning (NP) optimization problem, the Max2Sat (M2SAT) optimization, the Quadratic Knapsack (QK) optimization problem, the Subgraph Isomorphism (SI) optimization problem, the MaxCut (MC) optimization problem, the Set Partitioning (SPP) optimization problem, the Max3SAT (M3SAT) optimization problem, the Maximum Clique (MCQ) optimization problem, the Minimum Vertex Cover (MVC) optimization problem, the Graph Coloring (GC) optimization problem, the Traveling Salesperson Problem (TSP) optimization problem, the Set Packing (SP) optimization problem, the Quadratic Assignment optimization problem, and the Graph Isomorphism (GI) optimization problem.

The embodiments disclosed herein implement one or more machine learning models. As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

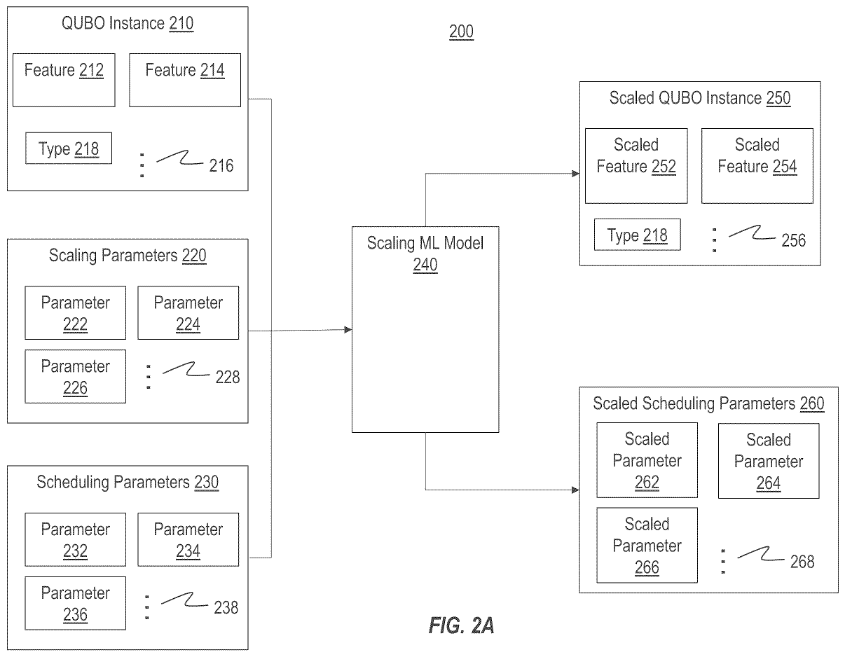

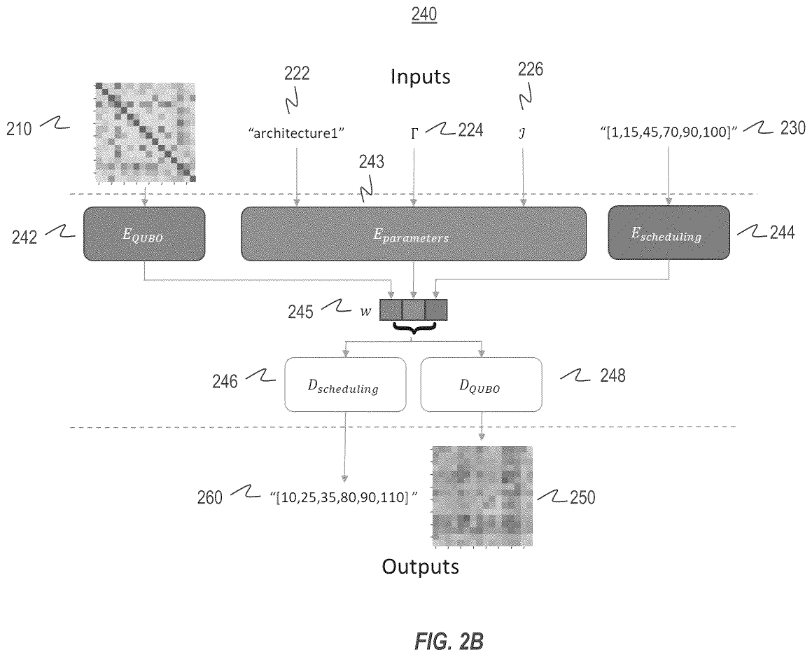

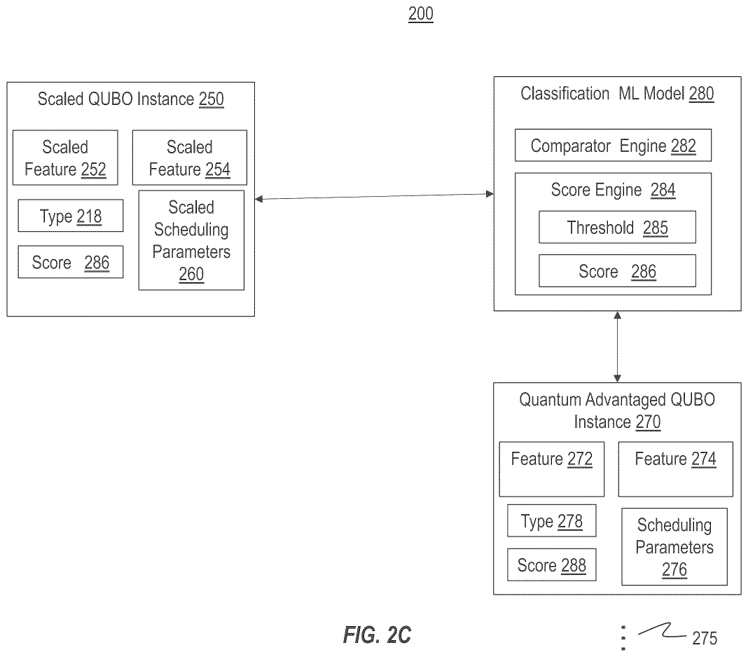

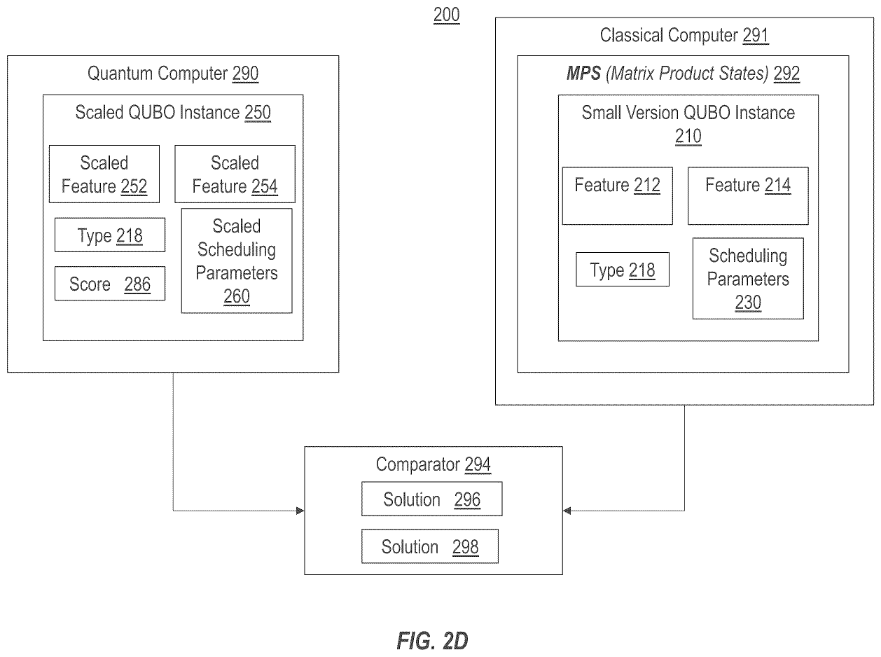

FIGS. 2A-2D illustrate an environment 200 where the embodiments disclosed herein may be practiced. In particular, the environment 200 may use various machine learning (ML) models to determine if a quantum simulation problem implemented as a QUBO can be simulated efficiently using a quantum computer.

As illustrated in FIG. 2A, the environment 200 includes a QUBO instance 210. The QUBO instance 210 includes various features (or at least metadata about the features). For example, the QUBO instance 210 includes a feature 212, a feature 214, and any number of additional features 216 as illustrated by the ellipses. In one embodiment, the features 212, 214, and 216 may be controllable features that can be selected and changed as needed. In one embodiment, the features 212, 214, and 216 may include, but are not limited to, QUBO size, QUBO problem difficulty, QUBO coefficient interdependency, and QUBO variable connectivity. Of course, other QUBO related features may also be included in the QUBO instance 210.

The QUBO instance 210 also includes a problem type feature 218 that defines the problem type or structure of the QUBO instance 210. For example, if the QUBO instance 210 was a Max3SAT optimization problem, it would have one problem type feature 218 and if it were the TSP optimization problem it would have a different problem type feature 218. Thus, problem type feature 218 will be different for each of the QUBO problem types discussed previously.

The environment 200 includes a scaling ML model 240. In operation, the scaling ML model 240 translates or maps the QUBO instance 210 into a scaled QUBO instance 250 that can be executed on a quantum computer. In the embodiment, the scaling ML model 240 may be any reasonable ML model such as a Generative AI model such as an explicitly controlled Generative Adversarial Network (GAN).

The scaling ML model 240 translates the QUBO instance 210 using various scaling parameters 220. For example, the scaling parameters 220 may include a scaling parameter 222, a scaling parameter 224, a scaling parameter 226, and any number of additional scaling parameters 228 as illustrated by the ellipses. In one embodiment, the scaling parameter 222 is based on the architecture of the quantum computer that will be used to execute the scaled QUBO instance 250 and thus is not controllable by a user. In the embodiment, the scaling parameter 224 is related to the transverse field Γ scale and the scaling parameter 226 is related to the Ising field scale I.

The scaling ML model 240 translates the QUBO instance 210 using various scheduling parameters 230. For example, the scheduling parameters 230 include a scheduling parameter 232, a scheduling parameter 234, a scheduling parameter 236, and any number of additional scheduling parameters 238 as illustrated by the ellipses. In the embodiment, the scheduling parameters 230 act as controls because quantum systems are probabilistic in nature. Thus, for example, if a simulation has a total run time of 10 seconds, the scheduling parameter 232 may specify a control modification be applied at second 1, the scheduling parameter 234 may specify a control modification be applied at second 4, and the scheduling parameter 236 may specify a control modification be applied at second 8. This would result in a specific final state of the quantum system. However, if the scheduling parameter 232 specified a control modification be applied at second 2, the scheduling parameter 234 specified a control modification be applied at second 6, and the scheduling parameter 236 specified a control modification be applied at second 9, this would in a different final state of the quantum system. Thus, in the embodiment the scheduling parameters 230 will help determine if the scaled QUBO instance 250 is able to be executed by the quantum computer.

As illustrated, the scaling ML model 240 receives the QUBO instance 210, the scaling parameters 220, and the scheduling parameters 230 as inputs. The scaling ML model 240 is then able to transform the QUBO instance and output the scaled QUBO instance 250. As illustrated, the scaled QUBO instance 250 includes a scaled feature 252, a scaled feature 254, and any number of additional scaled features 256 as illustrated by the ellipses. In addition, the scaling ML model 240 outputs scaled scheduling parameters 260 that include a scaled scheduling parameter 262, a scaled scheduling parameter 264, a scaled scheduling parameter 266, and any number of additional scheduling parameters 268 as illustrated by the ellipses.

FIG. 2B illustrates a specific embodiment of the scaling ML model 240. As illustrated, the scaling ML model 240 receives the QUBO instance 210, the scaling parameters 222, 224, and 226, and various scheduling parameters 230 as inputs. The QUBO instance 210 is fed to a QUBO encoder 242, the scaling parameters 222, 224, and 226 are fed to a scaling parameter encoder 243, and the various scheduling parameters 230 are fed to a scheduling encoder 244. In the embodiment, the encoders 242-244 may be Multi-Encoder Variational Autoencoders, although any other reasonable encoder may also be used.

In one embodiment, during a training phase, the encoders 242-244 may be trained in datasets specially built to consider the results of regular scaling procedures for small problems as this would provide a ground truth to the encoder's loss function. For example, for a given QUBO, different scales and schedules can be explored and then the combination that is closest to the simulated results can be selected as the ground truth.

The encoders 242-244 produce three embeddings, which are then combined into a single vector w 245. The vector w 245 is then fed into a scheduling decoder 246 and a QUBO decoder 248, which may be Multi-Encoder Variational Autodecoders. The scheduling decoder 246 outputs the scaled scheduling parameters 260 and the QUBO decoder 248 outputs the scaled QUBO instance 250.

FIG. 2C further illustrates the environment 200. As illustrated in FIG. 2C, the environment 200 further includes a classification ML model 280, which may be any reasonable classification model. The classification model 280 includes a comparator engine 282 and a score engine 284, whose operation will be described in more detail to follow.

During a training phase, the classification model 280 receives a set of QUBO instances and their associated scheduling parameters that can be solved efficiently by the quantum computer that will be used to solve the scaled QUBO instance 250. Thus, this set of QUBO instances acts as labeled data that is used to train the classification model 280.

As illustrated, a quantum advantaged QUBO instance 270 is an example of a QUBO instance and associated scheduling parameters that can be solved efficiently by the quantum computer. The quantum advantaged QUBO instance 270 includes features 272 and 274, which may be similar to the features of the QUBO instance 210 previously discussed. The quantum advantaged QUBO instance 270 includes a problem type feature 278 that defines the problem type or structure of the quantum advantaged QUBO instance 270. It will be noted that typically the QUBO problem type of the quantum advantaged QUBO instance 270 will be different from the QUBO problem type of the QUBO instance 210 and scaled QUBO instance 250 as the embodiments herein are leveraging a quantum advantaged QUBO instance of differing problem type, but of similar characteristics, to help determine if the QUBO instance 210 and scaled QUBO instance 250 is one that can be efficiently executed by the quantum computer.

As also shown, the quantum advantaged QUBO instance 270 is associated with quantum advantaged scheduling parameters 276. Finally, the quantum advantaged QUBO instance 270 includes a score or label 288 that indicates that the quantum advantaged QUBO instance 270 is a QUBO that can be solved efficiently by the quantum computer. In one embodiment, the score or label 288 is 1. The ellipses represent that there may be any number of additional quantum advantaged QUBOs 275 in the set of QUBO instances and their associated scheduling parameters that can be solved efficiently by the quantum computer that will be used to solve the scaled QUBO instance 250.

In operation, the classification ML model 280 receives the scaled QUBO instance 250 and the scaled scheduling parameters 260. It will be noted that in FIG. 2C the scaled scheduling parameters 260 are shown as part of the scaled QUBO instance 250 for ease of illustration as they are associated with the scaled QUBO instance 250 as previously described.

The comparator engine 282 compares the scaled features 252, 254, and any other scaled features with the features 272, 274, and any other features of the quantum advantaged QUBO instance 270, and features of the additional quantum advantaged QUBOs 275. In other words, the comparator engine determines if, although being of differing QUBO problem type, the scaled QUBO instance 250 and the quantum advantaged QUBO instance 270 (and/or one or more of the additional quantum advantaged QUBOs 275) have similar features or characteristics.

The score engine 284 then generates a score 286 for the scaled QUBO instance 250 based on how close the features and characteristics of the scaled QUBO instance 250 match the features and characteristics of the quantum advantaged QUBO instance 270. For example, suppose in one embodiment that the quantum advantaged QUBO instance 270 has a score 288 of 1, indicating that the quantum advantaged QUBO instance 270 can be efficiently executed by the quantum computer. In such embodiment, if the features and characteristics of the scaled QUBO instance 250 were relatively closely matched to the features and characteristics of the quantum advantaged QUBO instance 270, the score engine 284 would give the scaled QUBO instance 250 a score 286 that was relatively close to 1, for example somewhere between 0.7 and 1. However, if the features and characteristics of the scaled QUBO instance 250 were relatively not closely matched to the features and characteristics of the quantum advantaged QUBO instance 270, the score engine 284 would give the scaled QUBO instance 250 a score 286 that was not relatively close to 1, for example somewhere between 0.7 and 0.

In the embodiment, when the scaled QUBO instance 250 has a score 286 that is relatively close to the score 288, the scaled QUBO instance 250 is executed on the quantum computer and small versions of the QUBO instance 210 are simulated using MPS to verify that the scaled QUBO instance 250 can be executed efficiently as will explained in more detail to follow. However, when the scaled QUBO instance 250 has a score 286 that is not relatively close to the score 288, it is assumed that the scaled QUBO instance 250 cannot be efficiently executed on the quantum computer and thus no execution is done on the on the quantum computer and no simulation is done using MPS, thus saving on computing resources.

Accordingly, in some embodiments the score engine 284 includes a predetermined threshold 285 that specifies when the score 286 is considered to be relatively close to the score 288, thus causing the execution of the QUBO instance 250 and simulation of the small versions of the QUBO instance 210 to occur. For example, suppose in one embodiment that the predetermined threshold was set to 0.7. In the embodiment, if the score 286 is 0.7 or above, then the execution of the QUBO instance 250 and simulation of the small versions of the QUBO instance 210 would occur. However, if the score 286 is below 0.7, then the execution of the QUBO instance 250 and simulation of the small versions of the QUBO instance 210 would not occur.

FIG. 2D further illustrates the environment 200. As illustrated in FIG. 2D, the environment 200 further includes a quantum computer 290 and a classical computer 291 that is able to run the MPS 292 simulation. As discussed previously, when the scaled QUBO instance 250 has a score 286 that is relatively close to the score 288 or that is higher than the threshold 285, the scaled QUBO instance 250 is executed on the quantum computer and small versions of the QUBO instance 210 are simulated using MPS to verify that the scaled QUBO instance 250 can be executed efficiently.

Accordingly, as illustrated, the quantum computer 290 executes the scaled QUBO instance 250 based on the scaled scheduling parameters 260 and generates a solution 296. In addition, the classical computer 291 simulates one or more small versions of the QUBO instance 210 using MPS to generate one or more solutions 298. The one or more solutions 298 can be considered as a ground truth.

The solution 296 and the one or more solutions 298 are then provided to a comparator 294 that compares the solution 298 to the one or more solutions 298. Since the one or more solutions 298 can be considered as a ground truth, if the solutions are sufficiently close to each other, it can be assumed that scaled QUBO instance 250 can be efficiently executed on the quantum computer 290. Advantageously, the embodiment disclosed herein used the equivalence or similarity between the quantum advantaged QUBO instance 270 and the scaled QUBO instance 250 to help determine that the scaled QUBO instance 250 could be efficiently executed by the quantum computer 290. This in turn helps to save on computing resources in the manner previously described.

### C. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

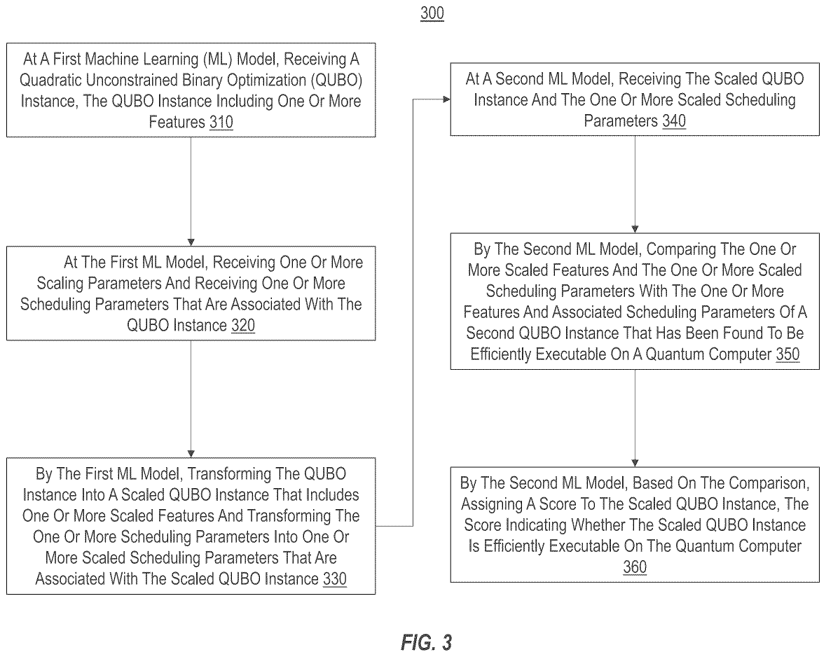

Directing attention now to FIG. 3, an example method 300 is disclosed. The method 300 will be described in relation to one or more of the figures previously described, although the method 300 is not limited to any particular embodiment.

The method 300 includes at a first machine learning (ML) model, receiving a Quadratic Unconstrained Binary Optimization (QUBO) instance, the QUBO instance including one or more features (310). For example, as previously described the scaling ML model 240 receives the QUBO instance 210 that includes the features 212 and 214 and the problem type feature 218.

The method 300 includes at the first ML model, receiving one or more scaling parameters and receiving one or more scheduling parameters that are associated with the QUBO instance (320). For example, as previously described the scaling ML model 240 receives the one or more scaling parameters 220 and the one or more scheduling parameters 230.

The method 300 includes by the first ML model, transforming the QUBO instance into a scaled QUBO instance that includes one or more scaled features and transforming the one or more scheduling parameters into one or more scaled scheduling parameters that are associated with the scaled QUBO instance (330). For example, as previously described the scaling ML model 240 transforms the QUBO instance 210 into the scaled QUBO instance 250 and the one or more scheduling parameters 230 into the one or more scaled scheduling parameters 260.

The method 300 includes at a second ML model, receiving the scaled QUBO instance and the one or more scaled scheduling parameters (340). For example, as previously described the classification ML model 280 receives the scaled QUBO instance 250 and the one or more scaled scheduling parameters 260.

The method 300 includes by the second ML model, comparing the one or more scaled features and the one or more scaled scheduling parameters with the one or more features and associated scheduling parameters of a second QUBO instance that has been found to be efficiently executable on a quantum computer (350). For example, as previously described the classification ML model 280 compares the scaled features 252 and 254 and the one or more scaled scheduling parameters 260 with the features 272 and 274 and the associated scheduling parameters 276 of the quantum advantaged QUBO instance 270.

The method 300 includes by the second ML model, based on the comparison, assigning a score to the scaled QUBO instance, the score indicating whether the scaled QUBO instance is efficiently executable on the quantum computer (360). For example, as previously described the classification ML model 280 assigns the score 286.

### D. Further Example Embodiments

Following are some further example embodiments of the invention. These are presented only by way of example and are not intended to limit the scope of the invention in any way.

Embodiment 1. A method, comprising: at a first machine learning (ML) model, receiving a Quadratic Unconstrained Binary Optimization (QUBO) instance, the QUBO instance including one or more features; at the first ML model, receiving one or more scaling parameters and receiving one or more scheduling parameters that are associated with the QUBO instance; by the first ML model, transforming the QUBO instance into a scaled QUBO instance that includes one or more scaled features and transforming the one or more scheduling parameters into one or more scaled scheduling parameters that are associated with the scaled QUBO instance; at a second ML model, receiving the scaled QUBO instance and the one or more scaled scheduling parameters; by the second ML model, comparing the one or more scaled features and the one or more scaled scheduling parameters with the one or more features and associated scheduling parameters of a second QUBO instance that has been found to be efficiently executable on a quantum computer; and by the second ML model, based on the comparison, assigning a score to the scaled QUBO instance, the score indicating whether the scaled QUBO instance is efficiently executable on the quantum computer.

Embodiment 2. The method as recited in embodiment 1, wherein the one or more scaling parameters comprise one or more of an architecture of the quantum computer that will be used to execute the scaled QUBO instance, the transverse field Γ scale, and the Ising field scale.

Embodiment 3. The method as recited in any of embodiments 1-2, wherein the first ML model is a Generative Adversarial Network (GAN).

Embodiment 4. The method as recited in any of embodiments 1-3, wherein the second ML is a classification model.

Embodiment 5. The method as recited in any of embodiments 1-4, wherein transforming the QUBO instance into the scaled QUBO instance and transforming the one or more scheduling parameters into the scaled scheduling parameters comprises: inputting the QUBO instance into a first encoder; inputting the one or more scaling parameters into a second encoder; inputting the one or more scheduling parameters into a third encoder; combining the outputs of the first, second, and third encoders into a single vector; inputting the single vector into a first decoder to thereby generate the one or more scaled scheduling parameters; and inputting the single vector into a second decoder to thereby generate the scaled QUBO instance.

Embodiment 6. The method as recited in any of embodiments 1-5, wherein the first, second, and third encoders are Multi-Encoder Variational Autoencoders.

Embodiment 7. The method as recited in any of embodiments 1-6, further comprising a threshold that specifies if the score is of a value that is indicative of whether the scaled QUBO instance is efficiently executable on the quantum computer.

Embodiment 8. The method as recited in any of embodiments 1-7, further comprising: executing the scaled QUBO instance on the quantum computer to generate a first solution when the score is higher than the threshold; simulating a small version of the QUBO instance on a classical computer that is executing a classical simulator to generate a second solution; and comparing the first solution to the second solution to verify that the scaled QUBO instance is efficiently executable on the quantum computer.

Embodiment 9. The method as recited in any of embodiments 1-8, wherein the classical simulator is Matrix Product States (MPS).

Embodiment 10. The method as recited in any of embodiments 1-9, wherein the one or more features of the QUBO instance include one or more of a QUBO size feature, a QUBO problem difficulty feature, a QUBO coefficient interdependency feature, and a QUBO variable connectivity feature.

Embodiment 11. A method for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-11.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

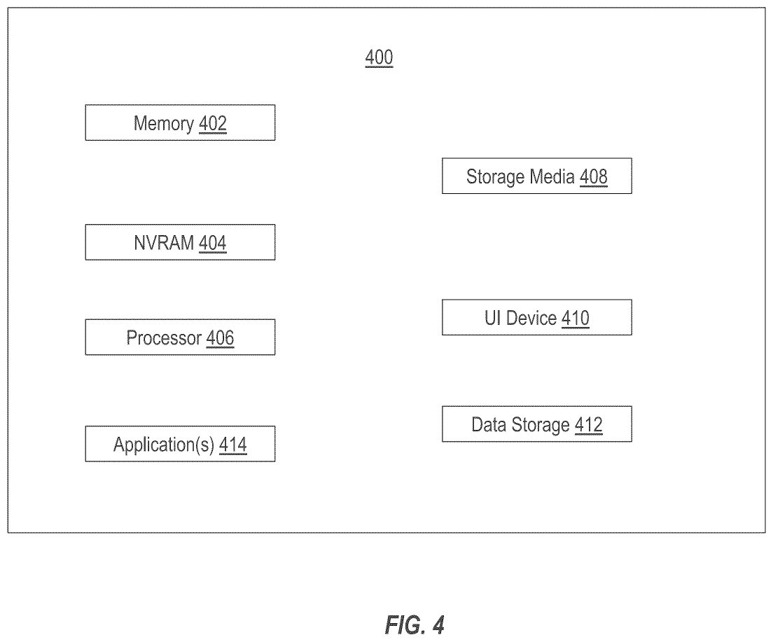

With reference briefly now to FIG. 4, any one or more of the entities disclosed, or implied, by FIGS. 1-3 and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 404 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
at a first machine learning (ML) model, receiving a Quadratic Unconstrained Binary Optimization (QUBO) instance, the QUBO instance including one or more features;
at the first ML model, receiving one or more scaling parameters and receiving one or more scheduling parameters that are associated with the QUBO instance;
by the first ML model, transforming the QUBO instance into a scaled QUBO instance that includes one or more scaled features and transforming the one or more scheduling parameters into one or more scaled scheduling parameters that are associated with the scaled QUBO instance;
at a second ML model, receiving the scaled QUBO instance and the one or more scaled scheduling parameters;
by the second ML model, comparing the one or more scaled features and the one or more scaled scheduling parameters with the one or more features and associated scheduling parameters of a second QUBO instance that has been found to be efficiently executable on a quantum computer; and
by the second ML model, based on the comparison, assigning a score to the scaled QUBO instance, the score indicating whether the scaled QUBO instance is efficiently executable on the quantum computer.

2. The method of claim 1, wherein the one or more scaling parameters comprise one or more of an architecture of the quantum computer that will be used to execute the scaled QUBO instance, a transverse field Γ scale, and a Ising field scale.

3. The method of claim 1, wherein the first ML model is a Generative Adversarial Network (GAN).

4. The method of claim 1, wherein the second ML is a classification model.

5. The method of claim 1, wherein transforming the QUBO instance into the scaled QUBO instance and transforming the one or more scheduling parameters into the scaled scheduling parameters comprises:
inputting the QUBO instance into a first encoder;
inputting the one or more scaling parameters into a second encoder;
inputting the one or more scheduling parameters into a third encoder;
combining outputs of the first, second, and third encoders into a single vector;
inputting the single vector into a first decoder to thereby generate the one or more scaled scheduling parameters; and
inputting the single vector into a second decoder to thereby generate the scaled QUBO instance.

6. The method of claim 5, wherein the first, second, and third encoders are Multi-Encoder Variational Autoencoders.

7. The method of claim 1, further comprising a threshold that specifies if the score is of a value that is indicative of whether the scaled QUBO instance is efficiently executable on the quantum computer.

8. The method of claim 7, further comprising:
executing the scaled QUBO instance on the quantum computer to generate a first solution when the score is higher than the threshold;
simulating a small version of the QUBO instance on a classical computer that is executing a classical simulator to generate a second solution; and
comparing the first solution to the second solution to verify that the scaled QUBO instance is efficiently executable on the quantum computer.

9. The method of claim 8, wherein the classical simulator is Matrix Product States (MPS).

10. The method of claim 1, wherein the one or more features of the QUBO instance include one or more of a QUBO size feature, a QUBO problem difficulty feature, a QUBO coefficient interdependency feature, and a QUBO variable connectivity feature.

11. A non-transitory storage medium having stored therein instructions that are executable by one or more hardware processors to perform operations comprising:
at a first machine learning (ML) model, receiving a Quadratic Unconstrained Binary Optimization (QUBO) instance, the QUBO instance including one or more features;
at the first ML model, receiving one or more scaling parameters and receiving one or more scheduling parameters that are associated with the QUBO instance;
by the first ML model, transforming the QUBO instance into a scaled QUBO instance that includes one or more scaled features and transforming the one or more scheduling parameters into one or more scaled scheduling parameters that are associated with the scaled QUBO instance;
at a second ML model, receiving the scaled QUBO instance and the one or more scaled scheduling parameters;
by the second ML model, comparing the one or more scaled features and the one or more scaled scheduling parameters with the one or more features and associated scheduling parameters of a second QUBO instance that has been found to be efficiently executable on a quantum computer;
by the second ML model, based on the comparison, assigning a score to the scaled QUBO instance, the score indicating whether the scaled QUBO instance is efficiently executable on the quantum computer.

12. The non-transitory storage medium as recited in claim 11, wherein the one or more scaling parameters comprise one or more of an architecture of the quantum computer that will be used to execute the scaled QUBO instance, a transverse field Γ scale, and a Ising field scale.

13. The non-transitory storage medium as recited in claim 11, wherein the first ML model is a Generative Adversarial Network (GAN).

14. The non-transitory storage medium as recited in claim 11, wherein the second ML is a classification model.

15. The non-transitory storage medium as recited in claim 11, wherein transforming the QUBO instance into the scaled QUBO instance and transforming the one or more scheduling parameters into the scaled scheduling parameters comprises:
inputting the QUBO instance into a first encoder;
inputting the one or more scaling parameters into a second encoder;
inputting the one or more scheduling parameters into a third encoder;
combining outputs of the first, second, and third encoders into a single vector;
inputting the single vector into a first decoder to thereby generate the one or more scaled scheduling parameters; and
inputting the single vector into a second decoder to thereby generate the scaled QUBO instance.

16. The non-transitory storage medium as recited in claim 15, wherein the first, second, and third encoders are Multi-Encoder Variational Autoencoders.

17. The non-transitory storage medium as recited in claim 11, further comprising a threshold that specifies if the score is of a value that is indicative of whether the scaled QUBO instance is efficiently executable on the quantum computer.

18. The non-transitory storage medium as recited in claim 17, further comprising:
executing the scaled QUBO instance on the quantum computer to generate a first solution when the score is higher than the threshold;
simulating a small version of the QUBO instance on a classical computer that is executing a classical simulator to generate a second solution; and
comparing the first solution to the second solution to verify that the scaled QUBO instance is efficiently executable on the quantum computer.

19. The non-transitory storage medium as recited in claim 18, wherein the classical simulator is Matrix Product States (MPS).

20. The non-transitory storage medium as recited in claim 11, wherein the one or more features of the QUBO instance include one or more of a QUBO size feature, a QUBO problem difficulty feature, a QUBO coefficient interdependency feature, and a QUBO variable connectivity feature.
